(19) United States
(12) Patent Application Publication
(10) Pub. No.: US 2024/0023562 A1
(43) Pub. Date: Jan. 25, 2024

(54) RING FOR TOPPING PIZZA AND OTHER FOOD PRODUCTS

(71) Applicant: Edge Exponential LLC, Gahanna, OH (US)

(72) Inventor: Jeremy Y. Mak, Hilliard, OH (US)

(21) Appl. No.: 18/225,254

(22) Filed: Jul. 24, 2023

Related U.S. Application Data
(60) Provisional application No. 63/391,473, filed on Jul. 22, 2022.

(51) Int. Cl. A21C 9/04; A23P 20/12

(52) U.S. Cl. CPC A21C 9/04; A23P 20/12

(57) ABSTRACT

An apparatus for topping food products that have a peripheral edge and an upper surface, wherein the food products rest upon a pan with a peripheral edge. The apparatus includes an annular guide with an axis and a guide surface terminating at an inner edge defining a central opening. The guide surface is substantially non-parallel to the axis, and may form an angle between about 20 and 60 degrees with the axis. An annular skirt is mounted coaxially to the annular guide and is disposed adjacent the peripheral edge of the pan. The inner edge of the guide surface is disposed a first predetermined distance from the food product's upper surface and a second predetermined distance radially inwardly of the food product's peripheral edge, thereby causing toppings dropped onto the annular guide to be guided radially inwardly of the inner edge.

### BACKGROUND OF THE INVENTION

The invention relates generally to food product equipment, and more specifically to a device used when adding toppings to a pizza crust, or other food product substrate, to guide the toppings to specific areas of the crust, or other substrate, and away from other areas.

It is well known that pizza is made by placing toppings, such as cheese, pepperoni and onions, on a circular or otherwise-shaped crust that may already have sauce on the top surface. Sauces can include common tomato-based and other less common sauces, such as Alfredo. A common means of placing toppings on a pizza crust is by hand, whereby the operator simply drops particles of topping (e.g., grated pieces of cheese, disks of pepperoni, etc.) at the locations desired. Hand-topping a pizza is time-consuming and requires skill to rapidly place toppings only where desired. Almost always, even with the best operators, toppings overlap or extend over the edge of the crust, which may be undesirable.

The prior art includes many devices that are used to reduce the probability of toppings being improperly placed on the crust edge. Most such devices are ring-shaped with substantially vertical sidewalls and rest upon the pizza crust during use. This results in the need to wash the device after every use, and leaves an undesirable indentation on the crust. The need exists for a device that results in a well-topped pizza crust that avoids the above-described and other disadvantages.

### SUMMARY OF THE INVENTION

Disclosed herein is an apparatus for use in topping a food product that has a peripheral edge when the food product rests upon a pan with a peripheral edge. The apparatus comprises an annular guide having an axis, an outer edge and a guide surface terminating at an inner edge. The inner edge defines a central opening and the guide surface forms a first angle relative to the axis. A distance between the inner edge and the axis is smaller than a distance between the outer edge and the axis. An annular skirt is mounted coaxially to the annular guide. The annular skirt has a radially inwardly-facing surface configured to be disposed adjacent a peripheral edge of the pan. Upon disposing the skirt's radially inwardly-facing surface adjacent the peripheral edge of the pan, the inner edge is disposed a first predetermined distance relative to the food product and a second predetermined distance radially-inwardly of a peripheral edge of the food product.

In some embodiments, the angle formed between the guide surface and the axis is between about 20 degrees and about 60 degrees. In some embodiments, a second angle is formed between the annular skirt and the axis in a range between about 1 and about 90 degrees. In some embodiments, a stop may be mounted to the radially inwardly-facing surface of the skirt. In some embodiments, the annular skirt and the axis are substantially parallel.

Also disclosed herein is a combination for topping a food product. The food product has a peripheral edge and an upper surface, and the food product rests upon a pan with a peripheral edge. The combination comprises an annular guide. The annular guide has an axis and a guide surface terminating at an inner edge defining a central opening. The guide surface is substantially non-parallel to the axis. An annular skirt is mounted coaxially to the annular guide and adjacent the peripheral edge of the pan. The inner edge is disposed a first predetermined distance from the food product's upper surface and a second predetermined distance radially inwardly of the food product's peripheral edge.

In some embodiments, an angle formed between the guide surface and the axis is between about 20 degrees and about 60 degrees. In some embodiments, an angle is formed between the annular skirt and the axis in a range between about 1 and about 90 degrees. In some embodiments, a stop is mounted to a radially inwardly-facing surface of the skirt, and the peripheral edge of the pan abuts the stop. In some embodiments, the annular skirt and the axis are substantially parallel. In some embodiments, the skirt has a radially inwardly-facing surface contacting the peripheral edge of the pan.

### BRIEF DESCRIPTION OF DRAWINGS

FIG. 1 is a view in perspective illustrating an embodiment of the present invention.

FIG. 2 is a section view in perspective illustrating the embodiment of FIG. 1 through the line 2-2.

FIG. 3 is a side view illustrating the embodiment of FIG. 1 resting upon a surface 8.

FIG. 4 is a view in perspective illustrating the embodiment of FIG. 1 in an inverted orientation.

FIG. 5 is a bottom view illustrating the embodiment of FIG. 1.

FIG. 6 is a top view illustrating the embodiment of FIG. 1.

FIG. 7 is a schematic side view in section illustrating the embodiment of FIG. 1 with a pizza pan and crust shown in an operable position.

FIG. 8 is a schematic side view in section illustrating the edge of a pan and crust relative to the FIG. 1 embodiment.

FIG. 9 is a schematic side view in section illustrating the edge of a pan and crust relative to an alternative embodiment of the present invention.

FIG. 10 is a schematic side view in section illustrating an alternative embodiment of the present invention.

FIG. 11 is a schematic view in section illustrating the embodiment of FIG. 10 in enlarged view.

FIG. 12 is a schematic side view in section illustrating an alternative embodiment of the present invention.

FIG. 13 is a top view illustrating the embodiment of FIG. 12.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

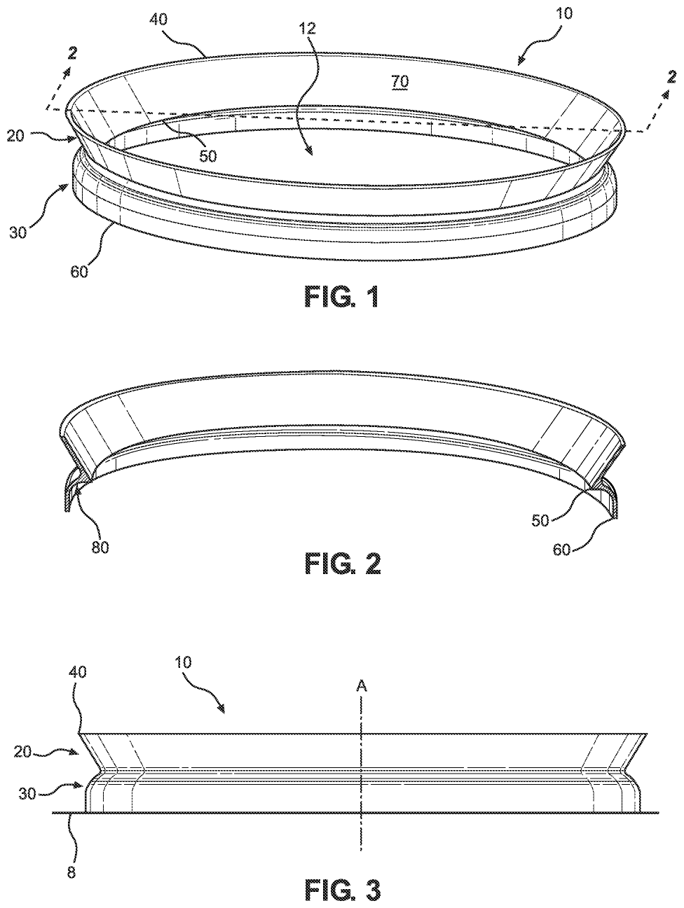

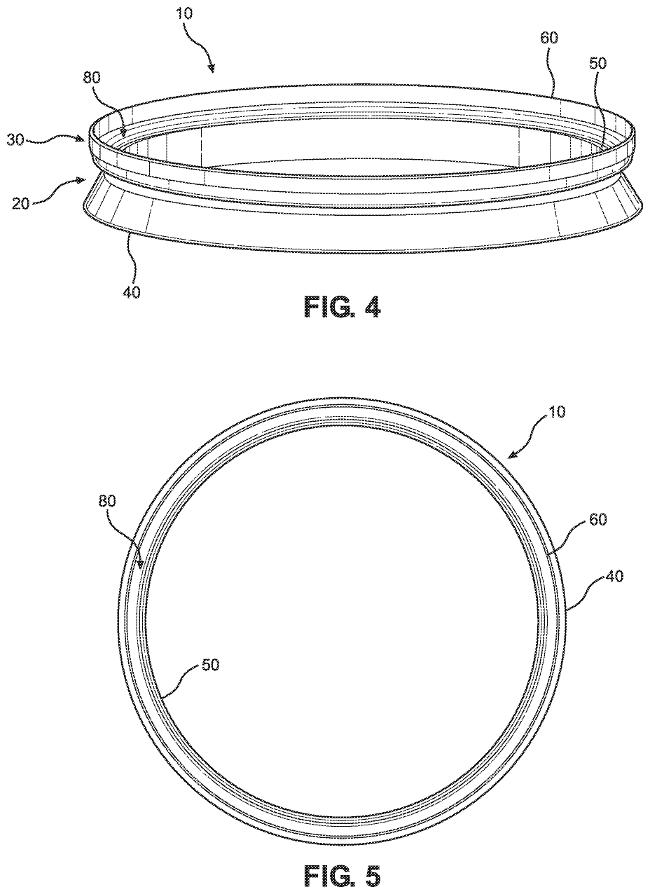

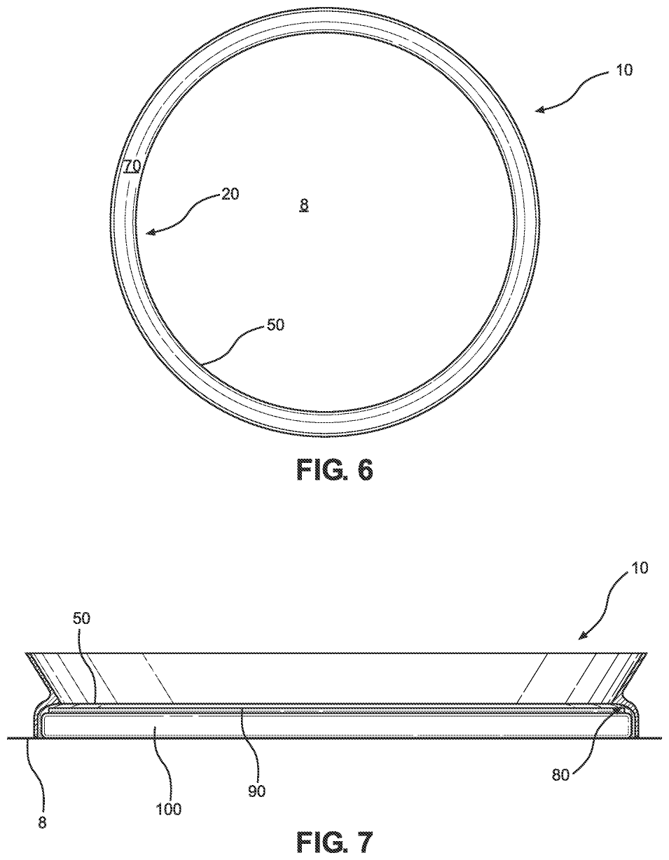

A ring 10 is shown in FIGS. 1-6 having a generally annular configuration with a generally circular structure having an opening 12 through the center that forms a void. “Annular” is defined herein as a structure that forms a closed loop, such as a circle, any polygon or any irregular shape, with an opening through the center. The ring 10 may be used for applying toppings to a pizza crust, such as by placing the ring 10 over a pizza pan in a coaxial position (FIG. 7) and dropping toppings through the opening 12 to the exposed crust surface. The ring 10 or an alternative ring may be used to top a pie in a pie pan, or a cake in a cake pan, and the ring 10 may be used with very flat cakes or other food products. “Pans” as defined herein are receptacles for food, which can be flat or cylindrical in shape, among others, and are made of any suitable material, such as metal (e.g., aluminum and cast iron), polymer/rubber (e.g., silicone) or ceramic.

For use with pizzas, the outer diameter of the ring 10 may be about 6 inches to about 18 inches, but the diameter may vary substantially from these dimensions for use on pizzas of any dimension or any other food product. The inner diameter may be about 5 inches to about 17 inches, but may vary substantially from these dimensions for use on pizzas of any dimension or any other food product.

The ring 10 may be made of plastic, metal, ceramic, a fiber-reinforced polymer composite, or any other suitable material. Contemplated metals include aluminum and aluminum alloys, and contemplated plastics include food safe polymers. Any suitable material may be substituted for these. The ring 10 may be made by any suitable manufacturing process, including metal spinning, cutting away excess material from a single block (e.g., machining), injection molding, three dimensional printing, or any acceptable process.

The ring 10 has structural components that facilitate use with a circular pizza pan, and it will be apparent to those knowledgeable in the field how to modify these components to work with other food products and other shapes. A toppings guide 20 extends around the ring 10 at one axial end of the ring. A pan-receiving skirt 30 extends around the ring 10 at the opposite axial end of the ring and is attached to the guide 20, such as by being molded with the guide 20, welding or any other suitable attachment. It is contemplated to mount the guide 20 on the skirt 30 by friction alone, or by any other temporary means of affixing. The guide 20 and skirt 30 are preferably annular and coaxial. In an operable position, the skirt 30 is preferably placed around the peripheral edge of a conventional pizza pan 100 as shown in section in FIG. 7, and in some embodiments the skirt is substantially parallel to the axis A.

An outer edge 40 may define the most radially-outward portion of the ring 10 and the guide 20, thereby forming the outer periphery of the ring 10. An inner edge 50 may define the most radially-inward portion of the ring 10 and is spaced axially from the outer edge 40. A contemplated distance from the outer edge 40 to the inner edge 50 is about 1.5 inches, but this distance is an example and not critical.

A lower edge 60 is axially opposite the outer edge 40, and is the lowest portion of the ring 10 when the ring is in an operable position, as shown in FIG. 3. A contemplated distance range from the lower edge 60 to the outer edge 40 is two to four inches, but this distance range is an example and is not critical. In some embodiments, the lower edge 60 rests during use upon a surface 8, such as a table or countertop. The table or countertop may be the same surface that supports a pizza pan 100 when the ring is in use with the pizza pan 100. The outer edge 40 is the highest point on the ring 10 when the ring is in an operable orientation, shown in FIGS. 3 and 7, with the outer edge 40 farthest above the surface 8 upon which the ring 10 and pan 100 rest.

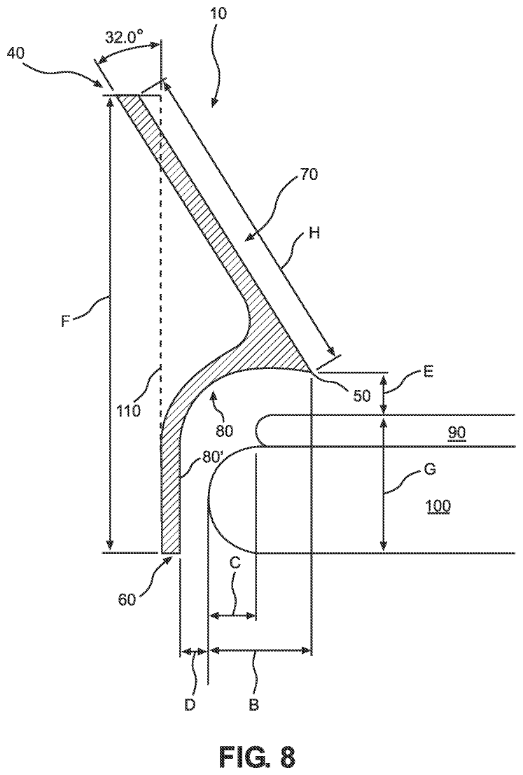

A guide surface 70 is formed on the radially-inwardly facing side of the guide 20 and extends between the outer edge 40 and the inner edge 50. The guide surface 70 may be non-parallel, i.e., angled, relative to the axis A (see FIG. 3) of the ring 10, and preferably guides particulate, which is dropped toward a pizza or other food product, radially inwardly. Thus, the inner edge 50 is closer to the axis A than the outer edge 40. In this manner, the guide surface 70 tends to move pizza toppings dropped thereon toward the center of the pizza crust in the manner of a funnel or ramp. The guide surface 70 preferably forms a guide angle between about 20 and about 45 degrees relative to the axis A of the ring 10. This guide angle may more preferably be between about 28.5 and about 40 degrees relative to the axis A of the ring 10. This guide angle may preferably be about 32 degrees as shown in FIG. 8 by the line 110 that is parallel to the axis of the ring 8. It is contemplated that the guide angle may be as large as about 60 degrees while remaining functional. Furthermore, guide angles as low as about 1.0 degree and as high as about 90 degrees are contemplated.

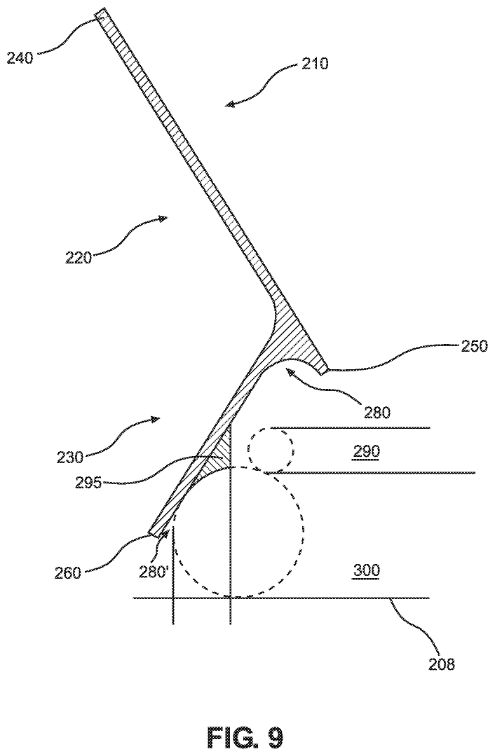

An annular groove 80 is defined adjacent the radially-inwardly facing curved sidewall of the skirt 30 between the lower edge 60 and the inner edge 50, as shown in FIGS. 2, 4 and 5. The groove 80 receives and extends over the outer edges of a crust 90 and a pan 100 (see FIGS. 7 and 8), over which the ring 10 may be placed during use. The views in section of FIGS. 7 and 8 show the ring 10 positioned operably over the pizza pan 100 and the crust 90, the peripheral edges of which are shown in the more magnified view of FIG. 8. In some embodiments, the groove 80 may be vertically shallow; that is, the vertical distance between the inner edge 50 and the deepest portion of the groove 80 may be small, such as about one-eighth of an inch or less. In other embodiments, such as FIG. 9, the groove is deep and the vertical distance may be one-half inch. In other embodiments, such as FIG. 11, the groove is flat and/or the deepest portion of the groove is at the same vertical position as, or below, the inner edge.

The annular guide 20 generally, and the guide surface 70 in particular, may have at least a portion that extends radially outside the peripheral edge of the crust 90, and optionally radially outside the peripheral edge of the pan 100, as shown in FIGS. 7 and 8. The annular guide 20 may have at least a portion that extends radially inwardly over the peripheral edge of the crust 90. This configuration causes toppings, such as grated cheese, that are dropped by hand or machine toward the crust 90 to be mostly unaffected by the ring 10 when they fall onto the central portion of the crust through the opening 12. Toppings that are dropped slightly outside of, and inside of, the periphery of the crust 90 strike, and are guided radially inwardly toward the center of the crust by, the sloped guide surface 70. The guide surface 70 thus guides toppings, which are intended to be placed near the crust edge, but fall instead onto the guide surface 70 at or near the crust edge, radially-inwardly from the edge of the crust 90. The guiding occurs under the force of gravity, which moves the topping downwardly along the sloped guide surface 70. This permits an operator using the ring 10 to define a clear border at or near a location on the crust just below the inner edge 50, inside of which toppings may be disposed without interference. Toppings may be dropped toward the clear border (e.g., by hand from above), but the toppings will not be disposed on the crust due to being guided radially inside the inner edge 50 by gravity as the toppings slide down the guide surface 70. Thus, the ring 10 reduces to none or close to none the amount of toppings that may fall on the crust 90 outside of the desired area.

In order to maintain this clear border at or near the inner edge 50, the ring 10, and specifically the inner edge 50, is spaced vertically a desired distance from the top of the crust and radially a desired distance from the outer edge of the crust. During use, the inner edge 50 is positioned a desired distance above the crust 90 and a desired distance radially-inwardly (to the right in FIG. 8) of the outer edge of the crust 90, as shown in the schematic illustration of FIG. 8. In a preferred embodiment, in an operable orientation, the ring 10 has a specific design in order to result in the desired spacing from the pizza crust and pan as referenced below.

The ability to obtain a clear border at or near the inner edge 50 of the ring 10 is affected by many factors, including the quantity and shape of cheese used, the guide angle and the shape of the cheese particles. Within the desirable ranges of guide angles, shallower angles (larger angles relative to the vertical axis A) result in more cheese located beyond the inner edge 50. Also, if one uses more cheese, the cheese typically flows radially outwardly past the inner edge 50 after ring removal. There is also a difference between the types of cheese and where the cheese particles will fall when the ring is removed after use. For example, long-feathered shred cheese does not move very much when the ring is removed after use. However, a finely diced or cubed cheese tends to be more dynamic and spills over more when the ring is removed after use. This means that, when using finely diced or cubed cheese, the inner edge 50 must be positioned farther radially-inwardly than when using long-feathered shred cheese, in order to obtain the same resultant clear border of cheese after removal of the ring.

The radial distance B (see FIG. 8) from the peripheral edge of the pan 100 to directly below the inner edge 50 is desired to be a particular distance, but may be within a preferred range. Distance B may preferably be about 0.45 inches and may vary from about 0.375 to about 0.625 inches for a 6-18 inch diameter pizza. This gives the finished pizza product an appearance of being topped “edge-to-edge” while still maintaining a desired portion of the crust radially outside the clear border having no toppings. When the distance B is in the desired range, the radial distance C from the edge of the crust to the edge of the pan may be about 0.208 inches for a 6-18 inch diameter pizza.

The radial distance D is the clearance gap between the peripheral edge of the pan 100 and the radially-inwardly facing surface 80′ of the skirt 30. This distance D is preferably 0.125 inches for a 6-18 inch diameter pizza and may be in a range of 0.1 to 0.15 inches. This distance D permits variations in pan diameters due to manufacturing tolerances and distortion of pans over time due to use. It is desired to position the radially-inwardly facing circular surface 80′ coaxial with the peripheral edge of the pan 100 during use, because this accommodates imperfections in the ring 10 and the pan 100.

The distance E is the vertical gap between the inner edge 50 and the top surface of the crust 90. This distance E is preferably between 3/16 and ¼ inches for a 6-18 inch diameter pizza. In some embodiments, the distance E may be measured above the top surface of any sauce that has been placed on the crust 90. In the embodiments described herein, the ring is used on a pizza crust after placing the sauce on the crust. Some crusts have no sauce, and the rings described herein may be used on such crusts. The distance E, along with the distance B, directly affect how far the toppings may fall radially-outwardly past the inner edge 50 during and after ring 10 use. The falling of toppings radially-outwardly normally occurs when the operator removes the ring 10 from the pan 100 after adding toppings to the crust. In general, at least when E is greater than about ¼ inch, the higher the inner edge 50 is above the crust 90, the farther radially inwardly the inner edge 50 should be positioned during use in order to create a clear border of toppings on the crust. This is because a taller gap E permits toppings to fall farther radially outwardly than a shorter gap E during use and upon removal. Thus, the inner edge 50 must be placed radially inwardly to counter the phenomenon of a taller gap E above about ¼ inch. When E is under ¼ inch, to at least as small as about 0.06 inches, a difference in E makes little difference in how far radially outwardly the toppings fall during removal of the ring 10. In general, when E is between about 0.06 to 0.25 inches, the cheese diameter is about 0.8 inches larger than the ring inner diameter. When the gap E is above ¼ inch, the cheese diameter expands with larger E gaps.

The vertical distance F is the overall height of the ring 10. The distance F is preferably 2.0 inches for a 6-18 inch diameter pizza, but this distance may vary from 1.5 inches to 2.5 inches. This parameter F affects how far an operator's hands can fit into the interior opening 12 of the ring, specifically in the region within the inner edge 50, in a manner that is ergonomically healthy and sustainable. The angle of the guide surface 70 also affects how far an operator's hands may ergonomically reach into the interior void. Both the angle of the guide surface 70 and the distance F may be determined by the level of care the operator exhibits when applying toppings, and the need of the operator to reach a significant distance into the interior of the ring to add toppings.

The vertical distance G is the height from the bottom of the pan 100 to the top surface of the crust 90. This is commonly a distance of around 0.6 inches for a 6-18 inch diameter pizza, but can vary substantially. The distance G+E is an important distance, which may be 0.788 inches for a 6-18 inch diameter pizza in the embodiment of FIG. 8. Because in some embodiments the ring 10 rests upon the surface upon which the pan 100 rests, the ring should be manufactured with the distance G+E within a desired range in order for the distance E to be within an acceptable range as outlined herein.

The guide length H is the length of the guide surface 70, which is shown as 1.429 inches in FIG. 8, but can vary between one and six inches for a 6-18 inch diameter pizza.

An advantage of the ring 10 is that the ring fits entirely over the pan 100 and self-aligns with the pan 100 under the force of gravity or by the user forcing the ring 10 to align. This is due, in some embodiments, by a skirt that is substantially parallel with the axis of the ring. In a typical process of use, the operator places the ring over the top of the pan 100 and the crust 90 with the ring 10 in a roughly coaxial position with the pan 100. Ideally, the surface 80′ is disposed in contact with, or directly adjacent to, the pan's peripheral edge or the top of the pan's peripheral edge. Then the ring 10 is released or forced downwardly by the operator until the ring is aligned coaxially with the pan 100, as shown in FIG. 7. Once the ring 10 and pan 100 are coaxial, the operator drops toppings toward the crust 90, with at least some toppings typically falling onto the ring 10. The guide surface 70 is the upwardly facing surface of the ring, so the guide surface 70 guides radially-inwardly any toppings that strike the ring 10. When the topping process is completed, the operator removes the ring 10 by lifting upwardly and the ring is now ready for use on another crust. Upon lifting the ring 10 off the pan, any toppings resting against the ring 10, such as on the surface 70, may fall onto the crust 90, possibly to a position radially outward beyond the point on the crust above which the inner edge 50 was positioned during topping. A clear border is nevertheless formed on the crust, radially outside of which no significant amount of toppings are located, despite a small number of such toppings falling there. By disposing the inner edge 50 over the crust, as aligned with the pan's peripheral edge, the clear border can be well-defined beneath the inner edge 50.

Whereas prior art devices rest on the crust or sauce of a pizza, the device described herein does not. The ring 10 preferably rests on the surface, such as the countertop, that supports the pizza pan 100. Also, with prior art devices, the user centers the device over the crust before adding toppings. With the ring 10, the peripheral edge of the pan 100 locates the ring coaxial with the pan and the crust because the crust should be centered on the pan. The ring 10 thus preferably makes no contact with the crust or other food products, so sanitation requirements will be different than if the ring 10 rested in contact with the food during use.

An alternative embodiment of the present invention is shown in cross section in FIG. 9. The annular ring 210 rests upon the peripheral edge of a pan 300 and extends above the peripheral edge of a crust 290. FIG. 9 shows a cross-sectional view of one side of the ring 210 above the pan 300 and crust 290, similar in relative position to the ring 10 in FIG. 8, and the guide 220 having an angled guide surface. The ring 210 is disposed with the radially inwardly facing surface 280′ of the skirt 230 resting on or near the peripheral edge of the pan 300. The skirt 230 forms a non-parallel angle with the axis of the ring 210, such as of about 30 degrees, but the angle could be of any amount between about 1.0 degree and about 90 degrees. A radially-inwardly facing stop 295 may be formed on the surface 280′ to limit the distance the pan's 300 peripheral edge may extend toward the annular groove 280, but this stop 295 is optional. In an operable position, the annular groove 280 is disposed above the peripheral edge of the crust 290 and the pan 300. Thus, the inner edge 250 is spaced vertically above the top surface of the crust 290, as well as radially inwardly of the peripheral edge of the crust 290, much like the embodiment shown in FIGS. 7-8 and described above.

The embodiment of FIG. 9 has a lower edge 260 that does not rest on the surface 208 on which the pan 300 rests. Instead, the ring 210, and the inwardly-facing surface 280′ in particular, rests upon the pan 300 during use. The ring 210 is able to accommodate pans of various diameters due to the length of the surface 280′ formed on the skirt 230. The surface 280′ extends radially outwardly of the pan 300 so that slightly larger diameter pans, and pans that are not perfectly shaped, may still be received by the ring 210. A slightly larger diameter pan would require the ring 210 to rest slightly above the position of the ring 210 shown in FIG. 9. A slightly smaller diameter pan would not cause the ring 210 to rest slightly below the position of the ring 210 shown in FIG. 9 due to the stop 295. However, if the stop 295 were absent, the ring 210 would rest slightly below the position where the ring 210 is shown in FIG. 9. There is plenty of room on the skirt 230 to accommodate smaller diameter pans.

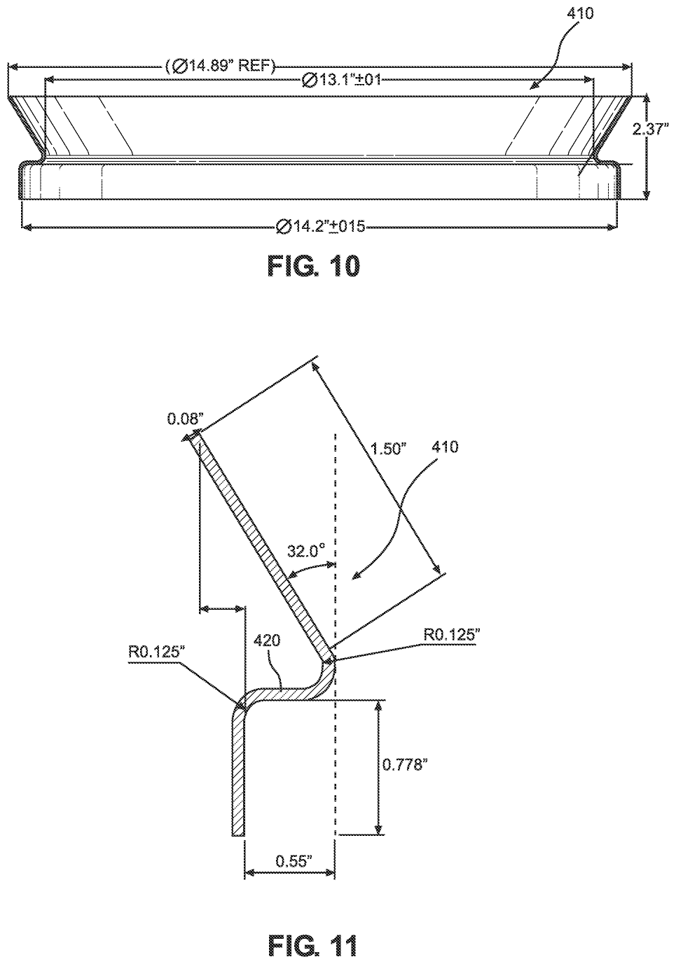

The ring 410 shown in FIG. 10, and in magnified cross-section in FIG. 11, is an alternative embodiment with an overall shape and size similar to the embodiments described above and shown in the illustrations. The ring 410 has a sidewall thickness that is substantially consistent along the entire structure, which is not uncommon in products manufactured in processes such as metal spinning.

One contemplated manner of manufacturing the ring 410 is to roll a rectangular strip of aluminum or steel sheet into an annulus, such as a hoop, after welding the overlapping end surfaces of the strip together. The hoop is mounted onto a 2-piece mandrel and the annulus is formed into the shape shown in FIGS. 10 and 11, such as by metal spinning or another forming process. As shown in FIG. 11, the horizontally-oriented member 420 may be horizontal, as shown, but may be angled to create an annular groove (similar to grooves 80 and 280 above) or similar.

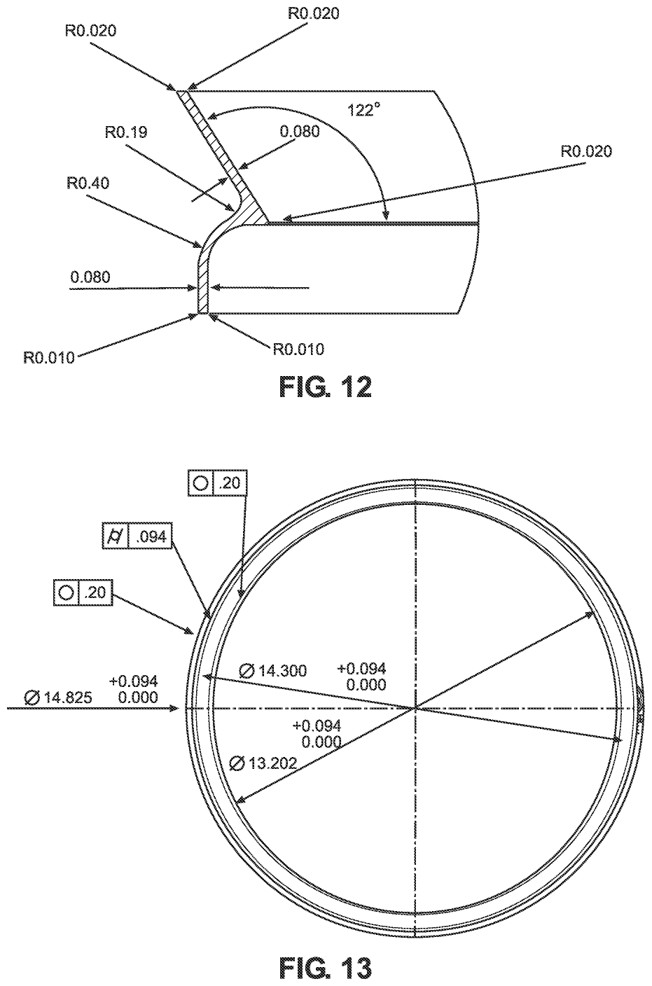

As shown in FIGS. 12 and 13, the features of the FIG. 8 embodiment, among others, may be modified from those shown in FIG. 8. For example, the structures at reference numerals 40, 50 and 60 may be modified from that shown in FIG. 8 to those shown in FIG. 12. This may include that some or all of the tip or end structures may have a radius of about 0.01 or 0.02 inches rather than the sharp or blunt structures shown in FIG. 8. Some or all structures of the embodiments of FIGS. 9 and/or 11 may also be modified to have similar radii to that shown in FIG. 12.

Of course, the details of the above rings would work in alternative shapes other than circular, including rectangular and rectangular with rounded corners, particularly when working with pans and crusts that are not circular. The rings shown and described herein would be modified, as will be understood by a person having ordinary skill in the art, to accommodate pan and/or crust shapes other than circular. Such rectangular, oval, and other shapes are accommodated by rings with a matching shape. Such rectangular, oval, and other shaped rings are considered “rings” despite not being circular, and are annular due to a central opening in a closed loop.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An apparatus for use in topping a food product with a peripheral edge, which food product rests upon a pan with a peripheral edge, the apparatus comprising:
(a) an annular guide having an axis, an outer edge and a guide surface terminating at an inner edge that defines a central opening, wherein the guide surface forms a first angle relative to the axis, and a distance between the inner edge and the axis is smaller than a distance between the outer edge and the axis; and
(b) an annular skirt mounted coaxially to the annular guide and having a radially inwardly-facing surface configured to be disposed adjacent a peripheral edge of the pan;
wherein, upon disposing the radially inwardly-facing surface of the skirt adjacent the peripheral edge of the pan, the inner edge is disposed a first predetermined distance relative to the food product and a second predetermined distance radially-inwardly of a peripheral edge of the food product.

2. The apparatus in accordance with claim 1, wherein the angle formed between the guide surface and the axis is between about 20 degrees and about 60 degrees.

3. The apparatus in accordance with claim 1, wherein a second angle is formed between the annular skirt and the axis in a range between about 1 and about 90 degrees.

4. The apparatus in accordance with claim 3, further comprising a stop mounted to the radially inwardly-facing surface of the skirt.

5. The apparatus in accordance with claim 1, wherein the annular skirt and the axis are substantially parallel.

6. A combination for topping a food product with a peripheral edge and an upper surface, which food product rests upon a pan with a peripheral edge, the combination comprising:
(a) an annular guide having an axis and a guide surface terminating at an inner edge defining a central opening, wherein the guide surface is substantially non-parallel to the axis; and
(b) an annular skirt mounted coaxially to the annular guide, the skirt disposed adjacent the peripheral edge of the pan, thereby disposing the inner edge a first predetermined distance from the food product's upper surface and a second predetermined distance radially inwardly of the food product's peripheral edge.

7. The apparatus in accordance with claim 6, wherein an angle formed between the guide surface and the axis is between about 20 degrees and about 60 degrees.

8. The apparatus in accordance with claim 6, wherein an angle is formed between the annular skirt and the axis in a range between about 1 and about 90 degrees.

9. The apparatus in accordance with claim 8, further comprising a stop mounted to a radially inwardly-facing surface of the skirt, wherein the peripheral edge of the pan abuts the stop.

10. The apparatus in accordance with claim 6, wherein the annular skirt and the axis are substantially parallel.

11. The apparatus in accordance with claim 10, wherein the skirt has a radially inwardly-facing surface contacting the peripheral edge of the pan.
